(19) United States
(12) Patent Application Publication
(10) Pub. No.: US 2019/0374978 A1
(43) Pub. Date: Dec. 12, 2019

(54) Reject Selection Device

(71) Applicant: Jose Borrell S.A., Denia (Alicante) (ES)

(72) Inventor: Jose Vicente Roig Borrell, Denia (Alicante) (ES)

(21) Appl. No.: 16/291,128

(22) Filed: Mar. 4, 2019

(30) Foreign Application Priority Data
Jun. 8, 2018 (ES) 201830560

(51) Int. Cl. B07C 5/36; B65G 47/34

(52) U.S. Cl. CPC B07C 5/367; B07C 5/362; B65G 47/34; B65G 2201/0211; B07C 2501/0081; B65G 2203/0208; B65G 2203/041; B07C 2501/009

(57) ABSTRACT

Provided is a reject selection device for selecting rejects from a set of dried fruit or nuts moved on a conveyor belt, the device including a support element with a central zone above the conveyor belt at a distance thereto, parallel and transversal thereto, a sensor suitable for detecting physical and/or chemical qualities of the dried fruit or nuts and the position thereof on the conveyor belt, suction means with a set of suction nozzles arranged in the central zone, and identification software in communication with the sensor and suction means for identifying rejected pieces of fruit or nuts and instructing the suction means to remove the rejected pieces from the conveyor belt.

### FIELD OF THE INVENTION

The present invention corresponds to the technical field of dried fruit or nut handling machines, specifically to a device for selecting rejects within a set of dried fruit or nuts, which allows the defective elements to be eliminated based on at least one given quality, prior to the handling of said dried fruit or nuts.

### BACKGROUND OF THE INVENTION

When handling dried fruit and nuts, they are usually found mixed with foreign elements, such as leaves, twigs, pieces of plastic, which is why an initial objective in said handling should be the elimination of both said foreign objects and possible units of fruit or nuts that do not meet the minimum acceptable conditions due to having irregularities, an inappropriate colour, poor condition, humidity, bitterness, etc.

Currently, the selection of rejects is carried out by means of two possible techniques, one of which is the ejection of air and the other the mechanical diversion of the rejects.

The technique that is based on the ejection of air attempts to detect rejects by different means and each time it locates an element susceptible to rejection, it sends a jet of air that generates a change in the trajectory thereof, which is usually launched into a particular place for its collection. This technique is usually more appropriate for materials having small dimensions, such as dried fruit or nuts, legumes, etc., which can be influenced by a jet of air.

On the other hand, the technique that utilizes mechanical deviation will, as with the previous technique, firstly try to locate the rejects by different means and once one has been detected, the movement of an element that can be comparable to an arm, finger or blade is activated, which separates said element from the flow of movement of the rest and directs it to a place where the rejects are collected. This technique, for its part, is more suitable for larger materials, such as fruits.

In the present case, which concerns the elimination of rejects in dried fruit or nuts, it would therefore be logical to use a system with ejection of air, however these also have certain drawbacks.

One of these is that systems that use this technique are limited in speed, so that the production level is reduced. This is due to the fact that if the material circulates at high speeds, when the jet of air is applied by the ejector, it will affect the reject element and all grains of fruit or nut that are fine but are arranged around the reject.

Consequently, the need for slower displacement of the fruit or nut forces the assembly of larger machines, thus implying a higher cost and a greater need for space dedicated thereto.

In addition, the precision obtained by means of these ejector systems is rather discreet, bearing in mind that in the majority of cases they are fixed systems which apply a jet of air when the reject element is supposed to pass, but that logically and based on the proximity of other materials, it can also affect said materials even if they are not rejects. In addition, these ejector systems tend to have high inertia, so their response time is slow and can lead to errors in the removal of correct rather than reject material.

On the other hand, ejection involves limitations due to the shape and nature of the elements to be eliminated. Thus, if we deal with fragile elements, the fact that they could be influenced by the ejection jet when attempting to hit a reject could affect their integrity. Likewise, elements exist that, due to their shape having complicated aerodynamics, can generate a Coand\check{a} effect in which the air is coupled to the shape of the reject element, reducing or even nullifying the thrust effect that it should have on it.

As an example of the state of the art, the reference documents U.S. Pat. No. 8,082,838, US20130081982, U.S. Pat. Nos. 55,095,537, 8,346,388, 5,779,058, 8,662,314 and 5,509,537 may be mentioned.

Reference document U.S. Pat. No. 8,082,838 defines a double-action cylinder and piston mechanism comprising a cylinder that is substantially closed at both ends by means of front and rear end walls, a piston that can be moved axially within the cylinder, a first zone defined between the piston and the rear end wall of the cylinder and a second zone defined between the piston and the front end wall of the cylinder.

It also comprises a piston rod extending from the piston through the front end wall of the cylinder, an air inlet hole for communication with said first zone of the cylinder, and at least one exhaust outlet which is exposed during the axial displacement of the piston to release the air distributed to the first zone of the cylinder through the air inlet hole.

This piston is sufficiently long as to prevent communication between the second zone and the exhaust outlet so that static air pressure can be maintained in the second zone of the cylinder to cushion the impact between the piston and the front end wall of the cylinder.

A pneumatic product rejection system with the indicated cylinder and piston mechanism is likewise outlined that has high- and low-pressure manifolds, a control valve and a blade at the free end of the piston rod, to push the rejects and displace them from their trajectory.

By means of the indicated cylinder and piston mechanism, a greater response speed of the blade is obtained. Nevertheless, it concerns a pneumatic system that turns out not to be valid for dried fruit or nuts due to the size thereof.

In addition, it concerns a shovel that can only act on one reject at a time and, therefore, in the situation that two rejects are moving in parallel, it will only be able to act on one of them. Placing more than one blade would be an option, which would mean incorporating a cylinder and piston mechanism for each one, making the rejection system significantly more expensive.

Reference document US20130081982 defines a machine that classifies the grains based on the colour they exhibit and in which the decrease in performance due to erroneous elimination of grains in good condition is prevented by the use of different selection algorithms that act upon different ejector output nozzles in a first and a second classification.

The result obtained in the optical detection means is acted upon by ejection means that apply a jet of air in a first classification and likewise in a second classification.

In this case, the improvement is basically that, by means of a second classification, the errors of a first classification can be expected to be corrected. But this solution is more expensive because it multiplies the costs of cases where there is a single classification and it continues to be an imprecise method because the air stream can easily carry away grains in good condition that are close to the reject. They also turn out to be imprecise due to the response time existing between the order given to the ejector and the action thereof.

Reference document U.S. Pat. No. 5,509,537 expounds an ejector for an electronic classification machine that has a detector to locate the presence of rejects in a product stream and generates an actuator signal in response to this detection to eliminate said reject.

It has an ejector finger that includes an elongated flexible base member that has a first end and a second end, where the first end is joined in a fixed way with respect to the product current, and a contactor made of a material that is sufficiently rigid to eliminate the rejects from the product current when the ejector is brought into contact therewith, said contactor being connected between the ends of said base member that is bent by means of an actuator.

In this case, although said document calls the finger an “ejector”, there is no ejection of any flow and it refers to a finger that acts by pushing the rejects that are in a fall flow and separates them therefrom.

Again, there are problems with this invention due to the response of the ejector finger to the action order not being instantaneous, which can lead to errors. In addition, this type of classification is mechanical, and is not suitable for the classification of dried fruit or nuts.

Reference document U.S. Pat. No. 8,346,388 sets out a system and method for the tactile classification of the plurality of small objects by means of automated piezoelectric sensors. The sensor detects the smoothness and mass of individual objects by measuring a force exerted and the total contact time for each object upon entering into contact with a detection surface of a piezosensor, upon which objects fall one by one in cascade. The quantified values of force and contact time are analysed and compared with two threshold values or a range of threshold values that are predetermined based on a database of optimal objects and undesirable objects normally obtained from a spectrum of objects that has been analysed and recorded to aid in the calibration of the system.

This system is aimed at elements with a larger size than dried fruit or nuts, because since the weight of dried fruit or nuts is so low, the level of precision of piezoelectric sensors should be very high in order to detect differences in weight of such a small order of magnitude. It also turns out to be a system that is only valid for separating elements that do not meet certain values related to the weight and state of roughness of the surface layer, but is not able to be applied to the selection of rejects through other factors, such as the colour of the fruit, the bitterness . . . .

Reference document U.S. Pat. No. 5,779,058 concerns a grain colour classification device that has optical detection media with lighting means that includes at least one light source with a spectral energy distribution in the visible light region and in the near-infrared region.

By means of said optical detection means, this classification apparatus is capable, with a single unit, of sorting and rejecting foreign materials which have a colour different to acceptable products in the region of visible light and of classifying and rejecting foreign materials with a colour similar to acceptable transparent products or elements such as, for example, pieces of glass, plastic or similar, in the near-infrared region.

Later, once the reject element has been detected, a jet of air that pushes the reject to a new trajectory different from that which it had is applied by an ejector.

In this case, it is aimed at specifically detecting colour differences in grains, and it would not be possible to detect rejects according to factors other than this. In addition, an ejection mechanism is utilised that can turn out to be quite imprecise due to the delay between the emission of the order thereto and the action of the ejector being able to affect grains that are not rejects. Moreover, as already mentioned above, this type of removal mechanism is likewise imprecise because the jet of air can affect grains in good condition that are found close to the reject.

Reference document U.S. Pat. No. 8,662,314 refers to an apparatus and classification method for separating items into a product stream using a mechanical diverter sensitive to an artificial vision system. It also includes, in one form of the invention, a combination of a classifying apparatus that uses an air ejector to remove foreign material and a mechanical diverter to redirect undesirable items from a product stream.

Therefore, in this case it concerns an apparatus that combines a mechanism formed by a series of mobile blocks in the manner of fingers with a concave form, which are capable of guiding certain elements into one or another trajectory, deviating them from the main trajectory, with an ejector that collaborates in the elimination of foreign elements of reduced size. In addition, by means of mobile blocks the diverter mechanism is formed by two diverters, one downstream of the other, in such a way that it is possible to determine many more diversion trajectories of the elements between the two, based on the needs.

In this case it can be seen how it is necessary to place an ejector in order to effectively eliminate rejects of a reduced size, since the mechanical means proposed are valid for elements larger than dried fruit or nuts, and therefore are not suitable for the case under concern.

Thus, a device or equipment has not been found in the state of the art that is capable of carrying out effective selection of rejects from a set of dried fruit or nuts or other products of reduced size based on any characteristic that is considered, whether it be physical or chemical, and that is capable of eliminating the reject in an accurate way, solving the inconveniences found today in the systems that perform these functions.

### SUMMARY OF THE INVENTION

The reject selection device, for the elimination, based on at least one given quality, of undesirable elements or defective products which are present in a set of dried fruit or nuts that are moved on a conveyor belt presented here, comprises a support element having a central zone formed by a longitudinal element with two opposite ends, located over the conveyor belt at a distance therefrom, said central zone being parallel to the belt and arranged transversely thereto, and two fixing arms for respectively fixing each of the ends of the central zone to one of the sides of the conveyor belt.

The device also comprises at least one sensor, suitable for detecting a physical and/or chemical quality of the fruit or nut and position thereof, as well as identification software that is connected to the sensor, for identification of at least said physical and/or chemical quality of the dried fruit or nuts, which determines whether it should be accepted or rejected.

Finally, the device has suction means for suction of defective products, which are connected to said identification software, which communicates the suction command of an element and the position thereof detected by the sensor, and a set of suction nozzles connected to said suction means, and arranged in the central zone of the support element, oriented towards the conveyor belt and located in at least two rows with alternate positions, according to the direction of the central zone.

According to a preferred embodiment, the suction means comprise a compressor or a suction pump, a pipe respectively connected to each suction nozzle and to the compressor or pump, and a valve for opening and closing said suction pump.

In this case and in a preferred embodiment, the pipes connected to the nozzles are vacuum pipes. In another preferred embodiment, the pipes connected to the nozzles are compressed air pipes, which work by means of the Venturi effect.

According to another aspect, in a preferred embodiment, the nozzles are fixed with respect to the central zone of the support element, while in another preferred embodiment, the nozzles are suitable for being moved with respect to the support element, in a movement approaching towards the conveyor belt, prior to suction therethrough.

According to a preferred embodiment, the at least one sensor is formed by a vision camera, and/or X-rays, and/or a hyperspectral camera, and/or a laser.

This reject selection device is, in a preferred embodiment, arranged in equipment or a machine for handling of dried fruit or nuts, and located in the zone thereof where said fruit or nuts enter.

In another preferred embodiment, the device forms a machine whose function is to eliminate the reject elements in a set of dried fruit or nuts.

A significant improvement over the state of the art is obtained with the reject selection device proposed here.

This is since a device is obtained that is capable of analyzing the dried fruit or nut grains that are moved on a conveyor belt and detecting those that do not meet certain minimum specifications in terms of physical and/or chemical qualities, and in addition to detecting this, it is provided with means of removing them from the conveyor belt, without affecting the rest of the fruit or nuts that pass therethrough.

It turns out to be a fast and efficient device, thanks to a reduced operating inertia that allows a rapid response of the suction means, thus allowing higher operating speeds and an increase in productivity that comes therewith.

Furthermore, thanks to the low inertia of the device, great advantages are achieved, such as being able to work with fragile products or with complicated aerodynamics.

It is a very effective device because it does not use an ejector, rather much more accurate means of suction thanks to the approach it makes towards the reject, when it is applying suction.

In addition, as it has more than one nozzle, it can handle the removal of more than one reject at the same time.

As those skilled in the art will appreciate, the present invention is not limited to the embodiments and arrangements described above. Other objects of the present invention and its particular features and advantages will become more apparent from consideration of the following drawings and detailed description of the invention.

### BRIEF DESCRIPTION OF THE DRAWINGS

FIG. 1 shows a schematic view in perspective of the reject selection device, for one mode of a preferred embodiment of the invention

FIG. 2 shows a schematic vertical view of the reject selection device, for one mode of a preferred embodiment of the invention.

### DETAILED DESCRIPTION OF THE INVENTION

The following detailed description illustrates the technology by way of example, not by way of limitation of the principles of the invention. This description will enable one skilled in the art to make and use the technology, and describes several embodiments, adaptations, variations, alternatives and uses of the invention, including what is presently believed to be the best mode of carrying out the invention. One skilled in the art will recognize alternative variations and arrangements, and the present technology is not limited to those embodiments described hereafter.

In view of the figures provided, it can be observed how in one mode of a preferred embodiment of the invention, the reject selection device (1) proposed here whose objective is the elimination, based on at least one given quality, of undesirable elements or defective products which are present in a set of dried fruit or nuts that are moved on a conveyor belt (2), comprises a support element (3), at least one sensor, identification software, suction means for suction of the detected defective elements, and a set of suction nozzles (4) connected to said suction means.

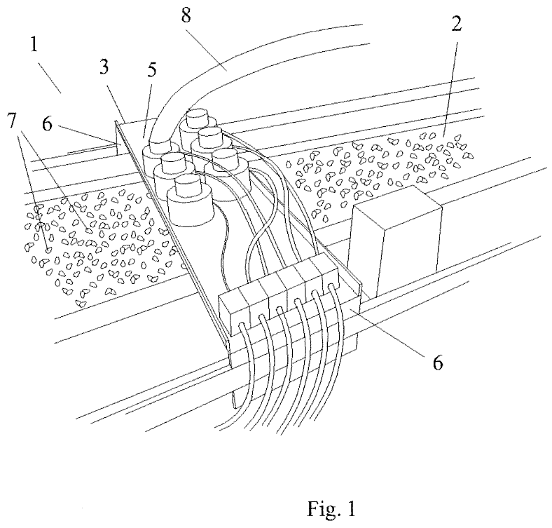

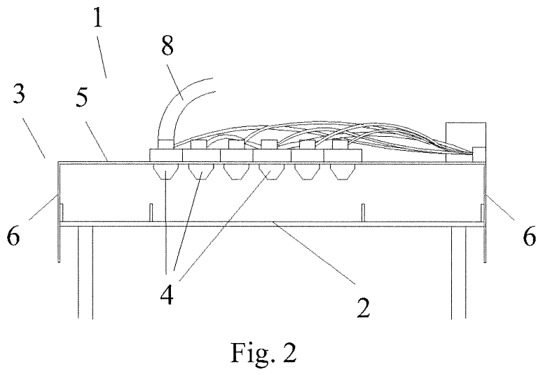

The support element (3), as shown in FIGS. 1 and 2, has a central zone (5) formed by a longitudinal element with two opposite ends, located over the conveyor belt (2) at a distance therefrom. This central zone (5) is located parallel to the belt (2) and transverse thereto.

Said support element (3) also has two fixing arms (6) for respectively fixing each of the ends of the central zone (5) to one of the sides of the conveyor belt (2).

For its part, this device (1) comprises a sensor that in this mode of preferred embodiment of the invention is formed by a hyperspectral chamber configured to detect humidity values in the fruit or nuts which are greater than a certain limit value.

In this case, therefore, the sensor is suitable for determining a chemical quality of the fruit or nut (7), in addition to the position thereof.

For its part, the identification software is connected to the sensor and analyzes said physical quality of the dried fruit or nuts (7), comparing the data collected with a previously developed model and, from this comparison, concludes whether the fruit or nut (7) should be accepted or rejected.

This identification software is connected to the suction means and communicates to them the suction command of a defective element, as well as the position thereof, which are detected by the sensor.

In this mode of preferred embodiment of the invention, the means of suction comprise a compressor, a pipe (8) respectively connected to each suction nozzle (4) and to the compressor, and a valve for opening and closing said compressor. In the Figures, only one pipe (8) connected to a suction nozzle (4) has been shown, so as not to interfere with the view of the rest of the parts of the device.

For their part, as shown in FIG. 1, the suction nozzles (4) are arranged in the central zone (5) of the support element (3), oriented towards the conveyor belt (2) and situated in this mode of preferred embodiment of the invention, in two rows with alternate positions, according to the direction of the central zone (5).

In this mode of preferred embodiment of the invention, the pipes (8) respectively connected to each suction nozzle (4), are formed by compressed air pipes and said suction nozzles (4) are suitable for moving with respect to the support element (3), in a movement approaching the conveyor belt (2), prior to suction therethrough.

In this way, the data collected by the sensor are sent to the software that by comparison with the previously developed model, determines the existence or non-existence of differences according to the established criteria, and concludes the necessity of rejection or not of the element in question. When it is concluded that it is a reject element and must be separated from the rest of the fruit or nuts, the software sends a signal to the suction means, with the position and time of action and these suction means send the command to the suction nozzle (4) closest to the position of the fruit or nut (7), in order that it approaches towards it and applies suction thereto.

If no differences are detected and therefore the existence of elements to be separated is not determined, the system does not act.

In this mode of preferred embodiment of the invention, the reject selection device forms an independent machine whose function is to eliminate reject elements from a set of dried fruit or nuts (7), but in other modes of embodiment it can form part of equipment or a machine for the handling of dried fruit or nuts, being arranged in the zone thereof where said fruits or nuts enter.

The form of embodiment described constitutes only one example of the present invention, and therefore, the specific details, terms and phrases utilized in the present specification should not be considered as limiting, rather they should only be understood as a basis for the claims and as a representative basis that provides an understandable description as well as sufficient information to the person skilled in the art to apply this invention.

With the reject selection device presented here, important improvements are obtained with respect to the state of the art.

A versatile device is achieved, which can constitute an independent machine or be coupled to an existing machine, at the entrance thereof, and turns out to be very effective for detecting foreign elements or those that do not meet established basic properties.

It significantly improves currently existing means of detection, since in many cases they are limited to the location of a single characteristic or focus on characteristics related to the weight or feel of the fruit or nut.

With this device it is possible to detect physical and chemical qualities and to also remove said elements detected as incorrect, without this interfering in the movement and normal trajectory of the rest of the fruit or nuts, thanks to the fact that an ejector which can affect the fruit or nuts around the reject is not utilized. When using a spray system that also approaches the reject at the time it is sucked up, the spray focus is more specific for the specific element that needs to be removed from the rest. It also results in a device with a very low inertia, so that the spray means react very rapidly thanks to very short start-stop times, which favors high precision in capturing rejects.

On the other hand, thanks to the existence of several spray nozzles, action for the elimination of more than one reject at the same time is possible, since it is possible that, together with the flow of dried fruit or nuts there are, for example, two rejects arranged parallel to the direction of the flow. In this case, a single nozzle would not be able to handle both rejects, but this selection device, which has a set of nozzles, is capable of carrying this out.

In addition, it is simple to apply and is suitable for use with fruit or nuts of reduced size, such as dried fruit or nuts, which is why it is very effective and favorable.

While the present invention has been described with reference to particular embodiments and arrangements of parts, features, and the like, it is not limited to these embodiments or arrangements. Indeed, modifications and variations included in these teachings will be ascertainable to those of skill in the art.

What is claimed is:

1. A reject selecting device for the elimination, based on at least one given quality, of undesirable elements or defective products present in a set of dried fruit or nuts moved on a conveyor belt, comprising:
a support element comprising:
a central zone formed by a longitudinal element with two opposite ends, said central zone being located above a conveyor belt at a distance therefrom and being parallel to the conveyor belt and arranged transversally thereto; and
two fixing arms for respectively fixing each of the ends of the central zone to one of the sides of the conveyor belt;
at least one sensor suitable for detecting at least one physical or chemical quality of each piece of the dried fruit or nuts and the position thereof;
suction means for removing defective pieces of dried fruit or nuts, said suction means comprising a set of suction nozzles arranged in said central zone of said support element, said suction nozzles being oriented towards said conveyor belt, arranged in at least two rows with staggered positions, and spanning the length of said central zone of said support element
identification software in electronic communication with said at least one sensor and said suction means, said identification software determining whether each piece of the dried fruit or nuts should be accepted or rejected and activating the suction means to remove rejected pieces detected by the at least one sensor.

2. The reject selection device according to claim 1, wherein said suction means further comprise a compressor or a suction pump, a pipe connected to each suction nozzle and to the compressor or pump, and a valve for opening and closing said suction pump.

3. The reject selection device according to claim 2, wherein said pipes connected to said suction nozzles are vacuum pipes.

4. The reject selection device according to claim 2, wherein said pipes connected to said suction nozzles are compressed air pipes.

5. The reject selection device according to claim 1, wherein said suction nozzles are fixed with respect to the central zone of the support element.

6. The reject selection device according to claim 1, wherein said suction nozzles are movable with respect to the support element in a movement direction toward and away from the conveyor belt.

7. The reject selection device according to claim 1, wherein said at least one sensor comprises one of a vision camera, an X-ray device, a hyperspectral camera, or a laser.

8. The reject selection device according to claim 1, the reject selection device being connected to equipment for the handling of dried fruit or nuts and being located in a zone thereof where said fruit or nuts are introduced.

9. The reject selection device according to claim 1, wherein the reject selection device is a standalone, independent machine.
